(19) United States
(12) Patent Application Publication
(10) Pub. No.: US 2015/0135768 A1
(43) Pub. Date: May 21, 2015

(54) SURVIVAL DOG TAGS

(71) Applicants: Shawn D. Barrick, Catonsville, MD (US); Diana L. Barrick, Catonsville, MD (US)

(72) Inventors: Shawn D. Barrick, Catonsville, MD (US); Diana L. Barrick, Catonsville, MD (US)

(21) Appl. No.: 14/515,117

(22) Filed: Oct. 15, 2014

Related U.S. Application Data
(60) Provisional application No. 61/961,426, filed on Oct. 15, 2013.

(51) Int. Cl. G09F 21/02; F23Q 1/06; B23D 61/18; A44C 15/00; G09F 3/02

(52) U.S. Cl. CPC G09F 21/02; A44C 15/005; G09F 3/02; B23D 61/185; F23Q 1/06
USPC 63/1.12

(57) ABSTRACT

A survival kit is disclosed which provides multiple survival tools. The kit has at least two dog tag survival tools which are removably suspended from a user's neck by a necklace. The necklace has a suspension cord with a length of paracord braided about the outer surface of the suspension cord. The paracord can be un-braided for use as a survival tool. One dog tag has a saw attached to a long edge thereof and another dog tag has a ferrocerium or flint rod attached to a long edge. The dog tags are made of thick aluminum or stainless steel such that it is virtually impossible to bend the dog tag using one's hands. This permits the ferrocerium or flint rod to be struck with the saw to provide sparks for starting fires. A magnifying lens or, optionally, a button compass is provided in the dog tag carrying the ferrocerium or flint rod. The dog tags are provided with an elastic sheath/cover to prevent noise, to protect them and for stealth purposes. At least one surface of each dog tag is highly polished for signaling purposes.

### CROSS-REFERENCE TO RELATED APPLICATIONS

This application claims the benefit of U.S. Provisional Application 61/061,426, filed on Oct. 15, 2013.

### STATEMENT REGARDING FEDERALLY SPONSORED RESEARCH OR DEVELOPMENT

Not Applicable

### SEQUENCE LISTING

Not Applicable

### BACKGROUND OF THE INVENTION

Identification Dog tags

Tags for use by soldiers for identification purposes have been known since at least as early as the Taiping revolt [1851-1866]. Soldiers wore a wooden tag at the belt, which bore the soldier's name, age, birthplace, unit and date of enlistment. During the American Civil War [1861-1865] it was common for soldiers to pin paper notes with their name and home address to the backs of their coats. The Prussian army issued identification tags for its troops during the Franco-Prussian War [circa 1870]. These tags were nicknamed Hundemarken [the German equivalent of “dog-tags”] and were somewhat similar to an identification system for dogs used in the city of Berlin.

The British, Canadian, Australian and New Zealand armies issued identification tags from the beginning of World War I [1914]. Theses “dog tags” were identification disks made of fiber. The disks were color-coded with one being colored red and the other colored green. They were suspended around the neck of the soldier by butcher's twine. A similar “dog-tag” was used by theses armies during WWII and the Korean War. These early uses of dog tags provided identification for the soldier in the event of death or a serious wound.

The U.S. Army first authorized identification tags in 1906. War Department General Order No. 204 requires the following:

“An aluminum identification tag, the size of a silver half dollar and of suitable thickness, stamped with the name, rank, company, regiment, or corps of the wearer, will be worn by each officer and enlisted man of the Army whenever the field kit is worn, the tag to be suspended from the neck, underneath the clothing, by a cord or thong passed through a small hole in the tab. It is prescribed as a part of the uniform and when not worn as directed herein will be habitually kept in the possession of the owner. The tag will be issued by the Quartermaster's Department gratuitously to enlisted men and at cost price to officers . . . ”

The Army later required soldiers to wear the identification tag at all times, not just when in uniform. In 1916, the Army started issuing each soldier two tags: one which would stay with the body and the other which would go to the burial authorities. In 1918, the Army adopted the serial number system the name and serial number of the soldier were stamped on each tag.

US dog tags are usually made from a relatively thin blank of embossable aluminum. The size of the aluminum blank can vary but a common size is for a dog tag approximately two inches long and one and one-eighth inches high with oval ends.

Around 1990, the Army officially stopped using the term dog tags replacing it with the designation ID tags; however, soldiers undoubtedly still call their ID tags “dog tags.” Today, the information inscribed on a GI's dog tag usually comprises the soldier's name, social security number, branch of service, blood group and religion.

Over the years, the composition, size and shape of dog tags [or ID Tags] has varied widely. In recent US military practice, dog tags have been relatively thin sheets of embossable metal which are strong enough to be rigid under normal handling situations but not strong enough such that they were impossible to deform or bend. These dog tags usually comprised a thin rectangular aluminum sheet with rounded edges approximately 2 inches in length and about one inch in height. Hereinafter in this application, this common type of dog tag will be referred to as a “GI dog tag”.

Dog tags have recently found their way into youth fashion by way of military chic. Originally worn as a part of a military uniform by youth wishing to present a tough or militaristic image, dog tags have since seeped out into wider fashion circles. They may be inscribed with a person's details, their beliefs or tastes, a favorite quote, or may bear the name or logo of a band or performer. Since the late 1990s, custom dog tags have become fashionable amongst musicians and as a marketing give-away item. Numerous companies offer customers the opportunity to create their own personalized dog tags with their own photos, logos, and text.

Survival Dog Tags

Survival dog tags are known among hunters, campers and other outdoor enthusiasts. They commonly provide a dog tag shaped device which will function as a knife and/or a signaling mirror.

The Original Dog Tag 4 in 1 Survival Knife, Rescue Mirror, Fire Starter, Compass [XTDOGTAG2] is a survival kit sold by Knife Center©. It comprises a polished, stainless steel survival knife shaped and sized as a dog tag with one long edge sharpened. The tag has a suspension hole near one side to receive a necklace so it can be worn around the neck. There is another hole placed in the center of the tag to aid in using the tag to signal a distant party using reflected light. The tag also has a semi-circular notch in the end opposite to the suspension hole. The purpose of this notch is to cooperate with a round ferrocerium rod which is separately provided as part of the kit. Sliding the ferrocerium rod along the semi-circular notch will give off sparks for fire-starting purposes. In addition, a button-compass is separately provided with the kit. The survival knife is also engravable. A protective elastic sheath is provided to protect the user from the sharpened edge of the survival knife

### SUMMARY OF THE INVENTION

The invention is a survival kit with at least a first and second dog tags attached to a single necklace comprising braided paracord. The survival kit of the invention gives the user multiple tools for survival. Each dog tag is shaped as a rectangle with rounded ends. The dog tags are dimensioned to resemble a normal GI dog tag being approximately 2 inches long and approximately 1 inch high. However, the dog tags are considerably thicker than a normal GI dog tag to provide better handling characteristics. It has been found that a desirable thickness for the dog tags of the preferred embodiment is approximately 3/16 of an inch thick. Obviously, the length and height of the dog tags could vary considerably from those given and still be within the scope of the invention so long as they are conveniently sized to be carried on a necklace about the user' s neck. The dog tag thickness could also vary from the dimension given so long as the dog tag was stiff enough to be virtually impossible to deform when being used as herein intended. Obviously, if desired, the dog tags might not be shaped to resemble a GI dog tag. For example, a triangular, ovid, square, etc. etc. shape could be used for the dog tag,.

The first survival tool is a length of paracord. This paracord is braided into a suspension necklace so that the dog tags can be worn around the user's neck. The paracord is braided about a separate and shorter suspension cord. This suspension cord can be used to support the remaining portions of the kit when the paracord has been un-braided for use. The second survival tool is a signaling device comprising the highly polished surface of either side of the first or the second dog tag. These surfaces function as a signaling mirror for sending messages using reflected light. The third survival tool is a small lens mounted in a hole in the central portion of the first dog tag. The fourth tool is a ferrocerium or flint rod affixed to a long edge of the first dog tag. The fifth tool is a saw blade affixed a long edge of the second dog tag. The sixth survival tool is a button compass which is embedded in the second dog tag. Optionally, the button compass can be embedded in a third dog tag which is also attached to the necklace. Obviously, in the embodiment with three dog tags, the button compass could be embedded in first dog tag and the lens mounted in the central portion of the third dog tag. It is envisaged that the kit may comprise either a lens or a button compass affixed to the first dog tag or the kit may comprise both the lens and the button compass with one affixed to the first dog tag and the other affixed to the third dog tag.

First Survival Tool

The suspension necklace is the first survival tool of the kit. The necklace is braided about a suspension cord to provide a necklace approximately 22 inches long to conveniently suspend the survival dog tags about the user' s neck. When un-braided, the necklace provides approximately 4 feet of paracord as a survival tool. The paracord is braided about a suspension cord comprising a length of cord about also 22 inches long so that the paracord can be un-braided and removed for use but such that the suspension cord can still be used to suspend the survival dog tags from the user's neck. The suspension cord could be made from ordinary waxed cotton cord or any other suitable material. In addition, the suspension cord could be made from a wire saw such that the suspension cord itself could be used as a saw. Obviously, the exact length of the paracord and suspension cord can vary from the dimensions given and still be within the scope of the invention. For example, it might well be possible to braid the paracord about the suspension cord with a special braiding which would give substantially more than 4 feet of paracord when unbraided.

The two ends of the suspension cord are fastened together with quick-release fasteners which will hold the necklace securely closed about the neck of the user against normal loads, but which will open when abnormal loads are applied to it. The quick-release fasteners are designed to separate at a per-determined force for safety reasons. This is to keep the dog tags secured about the user's neck in any normal situation, but to prevent the necklace causing injury to the neck [or strangulation] in the event the necklace becomes ensnared in an abnormal situation. Normal situations would comprise the usual motions associated with hiking, walking, running, and etc. A normal situation would also include a fall where the necklace did not catch on anything. An abnormal situation might result from a fall where the necklace catches a strong branch or rock or some other strong projection such that the user might become suspended by the neck from said strong branch, rock or etc. In this situation, the quick-release fasteners will open and permit the user to escape serious injury or strangulation.

In addition to the paracord necklace mentioned above, the suspension cord itself could, in need, be used as an additional survival tool. In addition, the suspension cord may, optionally, comprise a wire saw such that the suspension cord when removed from the kit may be used as a flexible saw.

Second Survival Tool

The second survival tool is the highly polished surface of either side of the first and second [or third] dog tag which can act as a signaling mirror to enable the user to send a signal a distant party using reflected light. This tool could be used as a signaling device in any situation, but would be especially useful in an emergency.

Third Survival Tool

The third survival tool is the small lens mounted in a hole in the first dog tag. This lens can provide a means for starting a fire when there is sufficient light available. Optionally, the lens can be mounted in a third dog tag.

Fourth Survival Tool

The fourth survival tool is the ferrocerium or flint rod affixed to a long edge of the first dog tag. The ferrocerium or flint rod of the preferred embodiment is adhered to a groove in the long edge of the first dog tag although any suitable means could be used to affix the ferrocerium or flint rod to the first dog tag. This ferrocerium or flint rod will produce sparks when struck or rubbed with the saw blade in the second dog tag. The tags are considerably thicker than a normal GI dog tag so that the user can grip the first dog tag with the ferrocerium or flint rod in one hand and the second dog tag with the saw blade in the other hand so that they may easily be struck or rubbed together to produce sparks for starting a fire. The dog tags of the invention are approximately 3/16 of an inch thick although other thicknesses are possible so long as the tag is stiff enough to be virtually impossible to deform when being subjected to the loads imposed upon it when being used as herein intended. It is noted that ferrocerium or flint rods are notorious for being brittle and easily breakable. One of the advantages of the preferred embodiment is the support given to the ferrocerium or flint rod by the body of the dog tag. This makes the ferrocerium or flint rod much stronger and more difficult to break under expected usage.

Fifth Survival Tool

The fifth survival tool is the saw blade affixed to one long end of the second dog tag. The primary purpose of this saw blade is to strike sparks from the ferrocerium or flint rod affixed to the first dog tag. The saw blade could be used for cutting rope, fabric, small branches, etc. and, it is also possible to use the saw blade as a weapon. It is partly because the first and second dog tags are intended to be struck or rubbed together [to produce sparks] that the thickness of the dog tags is considerably greater than normal GI dog tags. In addition, when the user holds the second dog tag [with the saw blade] in one hand while using the second dog tag to cut objects or as using it as a weapon a greater thickness for the dog tag is required to prevent bending and distortion of the dog tag body.

Sixth Survival Tool

The sixth survival tool is the button compass affixed to the first dog tag or, optionally, affixed to the third dog tag. The button compass can be mounted to the first [or third] dog tag by adhering it within a hole through the body of the dog tag. The compass can also be adhered directly to the surface of the dog tag or be adhered to the dog tag using a cavity in the tag which does not completely pierce the dog tag.

As noted above in paragraph [0016] the kit may have either the lens or the button compass or both.

### BRIEF DESCRIPTION OF THE DRAWINGS

FIG. 1 shows a plan view of the second dog tag with the saw blade affixed to the upper long edge of the dog tag.

FIG. 2 shows a plan view of the first dog tag with a ferrocerium or flint rod affixed to a groove in the upper long end of the tag and a lens mounted in a hole within the body of the tag.

FIG. 3 shows a top view of the first dog tag of FIG. 2 along the axis of arrow A in FIG. 2.

FIG. 4 shows a plan view of an alternate embodiment of the first dog tag with a ferrocerium or flint rod affixed to a groove in the upper long end of the tag and a button compass affixed to the body of the tag.

FIG. 5 shows a side view of the first dog tag as shown in FIG. 4 along the axis of arrow B in FIG. 4.

FIG. 6 shows the survival kit with first and second dog tags attached to the suspension necklace.

FIG. 7 shows a plan view of the second dog tag as shown in FIG. 1 covered with an elastic sheath/cover.

FIG. 8 shows a view of the suspension necklace shown in FIG. 6 showing the general arrangement of the braided paracord and the suspension cord.

### DETAILED DESCRIPTION

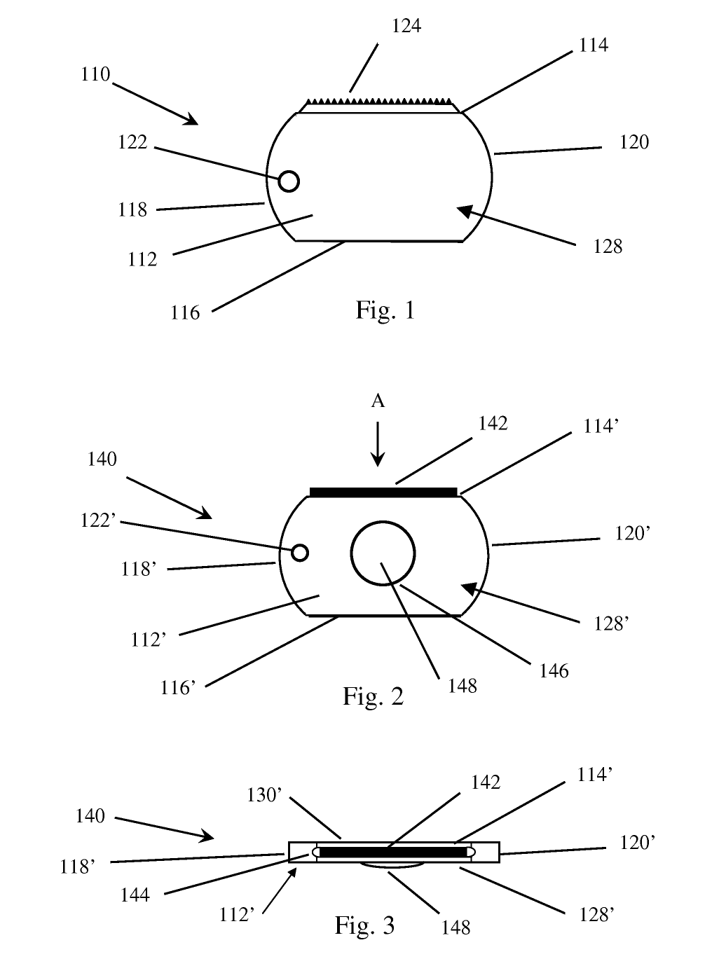

FIG. 1 shows second dog tag 110 comprising a body 112 made from a metal capable of retaining a high polished surface. Stainless steel and aluminum are preferred metals for body 112, but other materials could also be used as long as they are capable of holding a highly polished surface so the surfaces of body 112 can be used as a signal mirror. Body 112 is approximately two inches long and approximately one inch high having upper and lower long edges 114 and 116 with left and right rounded side edges 118 and 120. Body 112 has a suspension hole 122 bored near one of the side edges 118, 120. In this figure suspension hole 122 is shown near left rounded side edge 118, but it could just as well have been placed near right rounded side edge 120. Upper long edge 114 has a saw blade 124 adhered thereto. Saw blade 124 could be affixed to upper long edge 114 by any suitable means, however, in this instance, the blade is adhered to a slot [not shown] in the body near upper long edge 114. Body 112 has a highly polished front surface 128 suitable for use as a signaling mirror. Body 112 may also have a highly polished rear surface which can be used for signaling purposes, if desired [the rear surface is not shown in FIG. 1].

FIG. 2 shows first dog tag 140 comprising a body 112′ made from a metal capable of retaining a high polished surface. Because body 112′ is unobstructed by a lens or a button compass, it is envisaged that first dog tag 140 will be the primary signaling tool; however, second dog tag 110 also has at least one highly polished surface and can also be used as a signaling tool, if needed. It would not be quite as effective as first dog tag 140, but it could still be used. Body 112′ is approximately two inches long and approximately one inch high with upper and lower long edges 114′ and 116′ and with left and right rounded side edges 118′ and 120′. Body 112′ has a suspension hole 122′ bored near one of the side edges 118′, 120′. In this figure suspension hole 122′ is shown near left rounded side edge 118′, but it could just as well have been placed near right rounded side edge 120′. Upper long edge 114′ has a ferrocerium or flint rod 142 affixed thereto. Rod 142 is adhered to a mounting groove 144 in the body near upper long edge 114′. Mounting groove 144 is not shown in FIG. 2 but is illustrated in FIG. 3. A hole 146 is bored through body 112′ near the center of body 112′. A small lens 148 is mounted in this hole. Lens 148 is designed to concentrate light [usually from the sun] to aid in starting fires. Body 112′ has at least one highly polished surface 128′ or 130′ suitable for use as a signaling mirror. It is noted that rear surface 130′ is not shown in FIG. 2 but is shown in FIG. 3.

FIG. 3 shows first dog tag 140 in a top view along the axis of arrow A shown in FIG. 2. The front and rear surfaces 128′ 130′ of body 112′ are illustrated in this figure. Ferrocerium or flint rod 142 is affixed to body 112′ by means by means of an adhesive whihin groove 144 in the upper long edge 114′ of dog tag 140. Lens 148 is shown protruding slightly from front surface 128′.

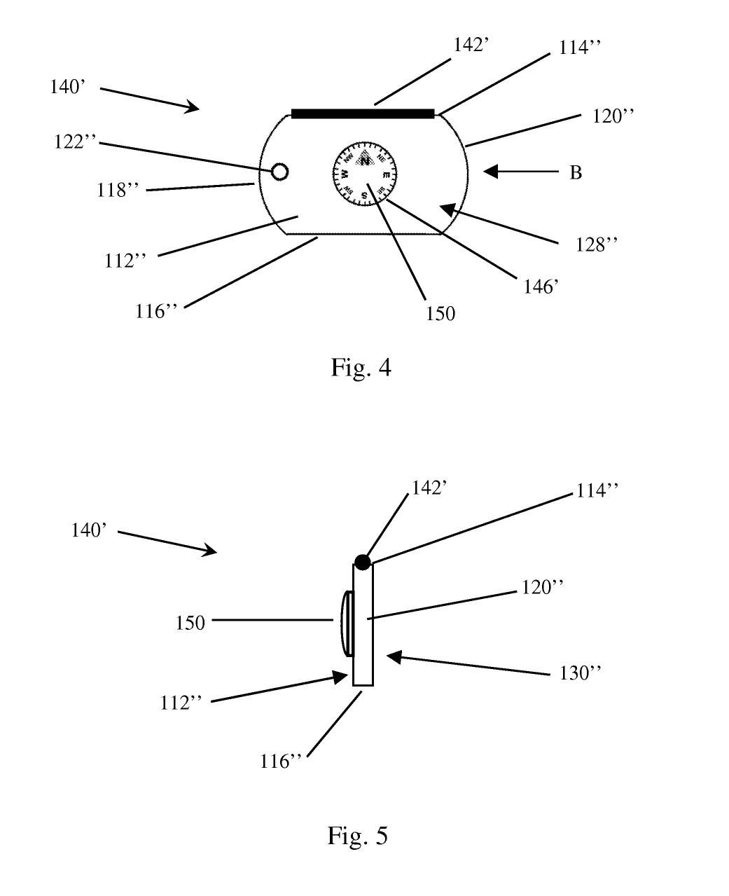

FIG. 4 shows an alternate embodiment of first dog tag 140′ having: a body 112″; upper and lower long edges 114″, 116″; left and right rounded edges 118″, 129″ ; suspension hole 122″; highly polished front surface 128″; ferrocerium or flint rod 142; and hole 146′ bored through body 112″ near the center thereof. A button compass is affixed within hole 146′ by any suitable means, e.g friction fit, glue, etc. Button compass 150 allows the user to determine direction.

FIG. 5 shows alternate embodiment of first dog tag 140′ in a side view along the axis of arrow B in FIG. 4. Body 112″ is shown with: upper and lower long edges 114″, 116″; rounded right edge 120″; front and rear highly polished surfaces 128″, 130″; ferrocerium or flint rod 142′; and button compass 150.

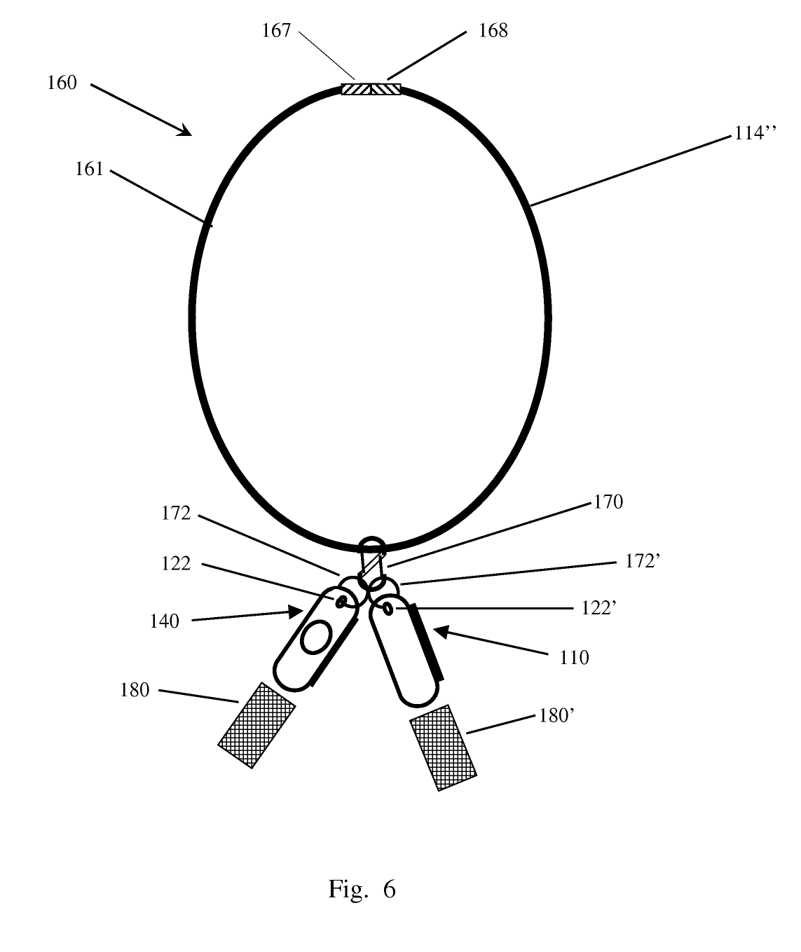

FIG. 6 shows the survival kit 160 comprising: first 140 and second 110 dog tags attached to suspension necklace 161. First dog tag 140 has a suspension hole 122 bored therein and second dog tag 110 has suspension hole 122′ bored therein. Suspension necklace 161 has an internal support structure, suspension cord 162 with paracord 164 braided about the outside surface of cord 162. The internal structure of necklace 161 is generally illustrated in FIG. 8 which also shows suspension cord 162.

The two ends of necklace 161 are held together by means of known quick-release fasteners 167 and 168 mounted to the two ends [not shown] of suspension cord 162. As noted above in paragraph [0017], these quick-release fasteners will hold necklace 161 about the neck of a user in any normal situation but will separate in need to prevent serious injury to the neck and/or strangulation of the user. As also noted above in paragraph [0018], because quick-release fasteners 167, 168 are attached to suspension cord 162, dog tags 140, 110 can still be worn about the user's neck after paracord 164 has been un-braided. This feature helps prevent dog tags 140, 110 from being lost after paracord 164 has been removed.

Dog tags 140 and 110 are mounted to necklace 161 by means of a device that will allow either one of dog tags 140 or 110 to be removed from necklace 161. In FIG. 6 this mounting device comprises a mini S-Carabineer 170. It is noted that any other suitable mounting means could be used as long as it would permit easy attachment and removal of the dog tags. Another possible mounting means would be a swivel lobster claw fastener. Other types of fasteners could be used and still come within the scope of the invention. Dog tags 140, 110 are mounted to mini S-Carabineer 170 using wire suspension coils 172, 172′ respectively which pass through suspension holes 122, 122′ respectively. These are similar to the ubiquitous wire coils used for holding keys together and comprise a short piece of wire bent into a circle.

Dog tags 140 and 110 are normally covered in use with elastic sheath/covers 180, 180′. These elastic sheath/covers easily slip over the dog tag and help to protect the user from injury caused by the saw blade 124. They also protect the dog tags from damage and reduce any noise created by the dog tags rubbing against each other or striking each other or some other object.

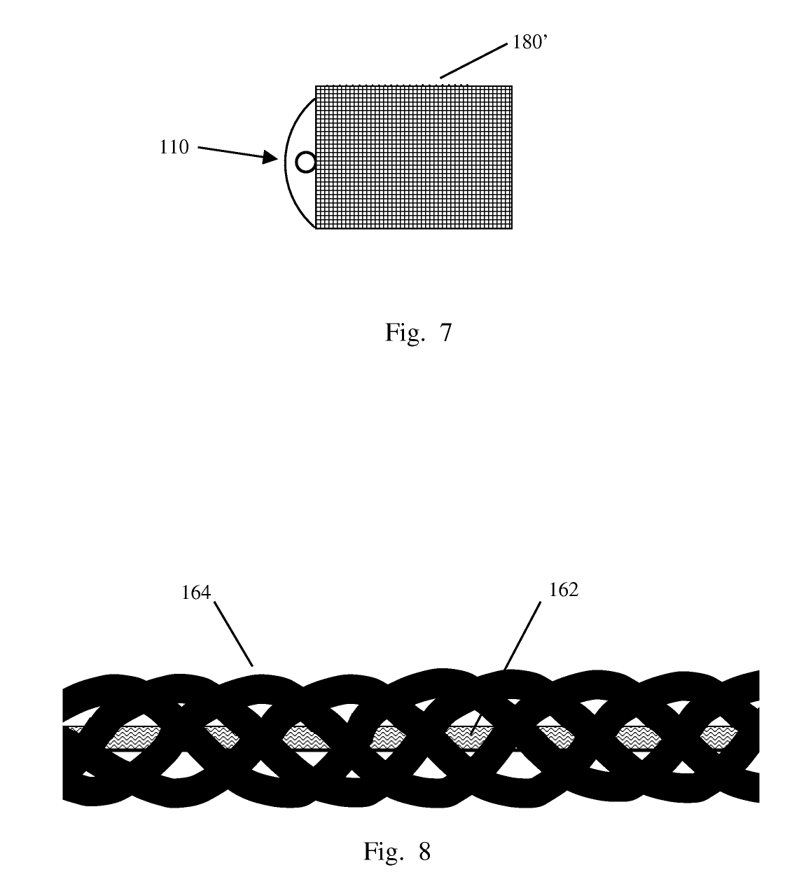

FIG. 7 shows dog tag 110 covered by elastic sheath/cover 180′. This cover protects the user from saw blade which dog tag 110 carries and it also protects the highly polished surfaces of dog tag 110. In addition, sheath/cover 180′ will greatly reduce the noise generated when the dog tags strike each other while being worn about the user's neck. Each of dog tage 140, 110 is provided with a sheath/cover as shown in FIG. 6.

FIG. 8 illustrates the general relationship of braided paracord 164 and suspension cord 162. Paracord 164 is braided around the outer surface of suspension cord 162. This permits the paracord to be un-braided for use while maintaining the suspension qualities of necklace 160 so that the dog tags 140, 110 may remain suspended about the user's neck even after the paracord is removed for use. The figure is not intended to illustrate the exact method of braiding used as there are a number of possibilities and any suitable scheme of braiding would fall within the scope of the invention as long as it would permit the full, unbroken length of paracord 164 to be braided about suspension cord 162 in a manner allowing paracord 164 to be un-braided for use without damage to suspension cord 162. As noted above in paragraph [0018], suspension cord 162 may, optionally, be a wire saw. Using a wire saw for suspension cord 162 would not inhibit the braiding of paracord 164 but would permit the suspension cord to be used as a flexible saw when it is separated from the remaining portions of the kit.

It is noted that it is within the scope of the invention to provide a kit with a conventional ball chain for suspending the dog tags about a user's neck. This would mean that the braided paracord would be eliminated from the survival kit suspended from the user's neck and would have to be carried separately or omitted altogether. It is also noted that it is within the scope of the invention to supply a survival kit with dog tags carrying a lens or with dog tags carrying a button compass. The kit could also be supplied with three dog tags, all suspended from the user's neck and include both the magnifying lens and the button compass.

1. A survival kit intended to be suspended from a user's neck comprising:
a necklace comprising a suspension cord with an unbroken length of paracord removably carried by said suspension cord;
at least a first and a second dog tag;
said at least first and second dog tags being made of a material which is capable of maintaining a highly polished surface and wherein at least one of said front and rear surfaces of at least one of said dog tags is highly polished;
a suspension means capable of removably suspending said at least first and second dog tags from said necklace; and,
wherein one of said first and second dog tags has a saw blade affixed to its long upper edge; and
an other of said first and second dog tags carries a bar affixed to its long upper edge which bar will strike sparks when struck with said saw blade.

2. The survival kit of claim 1 wherein said bar is a ferrocerium rod.

3. The survival kit of claim 1 wherein said bar is a flint rod.

4. The survival kit of claim 1 wherein each of said at least first and second dog tags is shaped as a rectangle having front and rear surfaces, long upper and lower edges and shorter left and right rounded edges and wherein said dog tag material is aluminum which is approximately 3/16 of an inch in thickness.

5. The survival kit of claim 1 wherein each of said at least first and second dog tags is shaped as a rectangle having front and rear surfaces, long upper and lower edges and shorter left and right rounded edges and wherein said dog tag material is stainless steel which is approximately 3/16 of an inch in thickness.

6. The survival kit of claim 1 wherein said paracord is removably braided about said suspension cord.

7. The survival kit of claim 1 wherein said suspension cord has first and second ends with a first quick-release fastener mounted to said first end of said suspension cord and a second quick-release fastener mounted to said second end of said suspension cord and wherein said quick-release fasteners interlock to hold said two ends together such that said suspension cord may be suspended about a user's neck.

8. The survival kit of claim of claim 7 wherein said first and second fasteners have a pre-determined break-away strength such that, upon application of said pre-determined force, said first and second quick-release fasteners will separate before causing injury to a user' s neck.

9. The survival kit of claim 1 wherein said other of said at least first and second dog tags has a hole bored through the dog tag which carries a magnifying lens.

10. The survival kit of claim 1 wherein said other of said at least first and second dog tags has a hole bored through the dog tag which carries a button compass.

11. The survival kit of claim 1 wherein each of said at least first and second dog tags have a suspension hole near one of said left or right rounded edges.

12. The survival kit of claim 11 wherein said suspension means further comprises a mini S-Carabineer.

13. The survival kit of claim 12 wherein each of said at least first and second dog tags has a wire suspension coil passed through the suspension hole in each of said at least first and second dog tags. and wherein said wire suspension coils are also attached to said mini S-Carabineer.

14. The survival kit of claim 11 wherein said suspension means further comprises a lobster claw swivel fastener

15. The survival kit of claim 14 wherein each of said at least first and second dog tags has a wire suspension coil passed through the suspension hole in each of said at least first and second dog tags and wherein said wire suspension coils are also attached to said swivel lobster claw fastener.

16. The survival kit of claim 1 wherein said suspension cord is made from waxed cotton.

17. The survival kit of claim 1 wherein said suspension cord further comprises a wire saw.

18. The survival kit of claim 1 wherein an elastic sheath is provided for each of said at least first and second dog tags which sheath can be slipped over each said dog tag.

19. The survival kit of claim 1 wherein there are three dog tags with the second dog tag having the attached saw and with the first and third dog tags having a ferrocerium rod attached to one long edge of said first and third dog tags and with said first dog tag carrying a magnifying lens and with said third dog tag carrying a button compass.
